(19) United States
(12) Patent Application Publication
(10) Pub. No.: US 2019/0305470 A1
(43) Pub. Date: Oct. 3, 2019

(54) CONNECTOR AND WATERPROOF CONNECTOR

(71) Applicant: Sumitomo Wiring Systems, Ltd., Yokkaichi (JP)

(72) Inventors: Shinpei Sugimoto, Yokkaichi (JP); Youjirou Hashimoto, Yokkaichi (JP)

(21) Appl. No.: 16/294,075

(22) Filed: Mar. 6, 2019

(30) Foreign Application Priority Data
Mar. 28, 2018 (JP) 2018-061048

(51) Int. Cl. H01R 13/52; H01R 13/424

(52) U.S. Cl. CPC H01R 13/5202; H01R 13/424

(57) ABSTRACT

A connector (30) to be fit into a receptacle (12) of a mating connector (10) includes a terminal holding portion (32) to be accommodated inside the receptacle (12) and an outer tube (33) to be fit outside the receptacle (12). The terminal holding portion (32) includes inner contacts (41) to be held in contact with an inner peripheral surface of the receptacle (12) in a properly connected state to the mating connector (10), and the outer tube (33) includes outer contacts (42) to be held in contact with an outer peripheral surface of the receptacle (12) in the properly connected state.

### BACKGROUND

### Field of the Invention

The invention relates to a connector and a waterproof connector.

Related Art

Japanese Unexamined Patent Publication No. 2007-200767 discloses a waterproof connector with two connectors that are connectable to each other so that fitting portions of the connectors are sealed by a seal ring. This waterproof connector includes a male connector holding a male terminal fitting and a female connector holding a female terminal fitting that is connectable to the male terminal fitting. The male connector has a receptacle surrounding the tip of the male terminal fitting. The female connector includes a terminal holding portion to fit inside the receptacle and an outer tube to fit outside the receptacle. The seal ring closely contacts the outer peripheral surface of the terminal holding portion and the inner peripheral surface of the receptacle when the male and female connectors are connected properly.

However, in the configuration as described above, a clearance is formed between the receptacle and the terminal holding portion or between the receptacle and the outer tube with the connectors properly connected. Thus, the connectors may rattle due to vibration. Rattling of the connectors must be prevented to avoid wear of contact parts of the terminal fittings due to sliding movements. Thus, a countermeasure has been desired.

The invention was completed on the basis of the above situation and aims to provide a connector and a waterproof connector capable of preventing rattling.

### SUMMARY

A connector of the invention is to be fit into a receptacle of a mating connector and includes a terminal holding portion to be accommodated inside the receptacle and an outer tube to be fit outside the receptacle. The terminal holding portion has an inner contact to be held in contact with an inner peripheral surface of the receptacle in a properly connected state to the mating connector. The outer tube has an outer contact portion to be held in contact with an outer peripheral surface of the receptacle in the properly connected state.

A waterproof connector of the present invention includes the connector and a mating connector having a receptacle configured to hold and surround a mating terminal fitting.

According to the invention, with the mating connector and the connector properly connected, the inner contact portion on the terminal holding portion is in contact with the inner surface of the receptacle, and the outer contact portion on the outer tube is in contact with the outer surface of the receptacle, thereby preventing the ratting of the connectors.

The connector may include a seal ring to be held in close contact with the inner peripheral surface of the receptacle and an outer peripheral surface of the terminal holding portion. The inner contact may project on the outer peripheral surface of the terminal holding portion, the outer contact may project on an inner peripheral surface of the outer tube, and a height of the inner contact from a surface held in close contact with the seal ring may be larger than a height of the outer contact from the inner peripheral surface of the outer tube portion. With the seal ring held in close contact with the inner peripheral surface of the receptacle and the outer peripheral surface of the terminal holding portion, an interval between the inner peripheral surface of the receptacle and the outer peripheral surface of the terminal holding portion tends to be larger than an interval between an outer peripheral surface of the receptacle and the inner peripheral surface of the outer tube. However, according to this configuration, the inner contact portion can be in contact with the inner peripheral surface of the receptacle.

The inner contact may be provided on a base that projects on the outer peripheral surface of the terminal holding portion. Accordingly, a height can be increased by the base. Thus, the height of the inner contact can be reduced, which is advantageous in strength.

The seal ring may be located in front of the base, and a fitting recess to be fit to the base is provided in a rear end part of the seal ring. According to this configuration, a dimension of the connector in a front-rear direction can be reduced as compared to the case where the entire seal ring is arranged in front of the base.

Two of the bases may be provided on upper and lower sides or on left and right sides of the terminal holding portion, and dimensions of the bases in a circumferential direction of the terminal holding portion may be equal. According to this configuration, since the fitting recesses on the upper and lower sides or left and right sides of the seal ring can be made equal, the seal ring can be used in a vertically or laterally inverted orientation.

The mating connector of the waterproof connector may be made of synthetic resin harder than the connector. According to this configuration, neither the inner contact portion nor the outer contact portion will damage the receptacle even if the waterproof connector is repeatedly connected and separated.

### BRIEF DESCRIPTION OF DRAWINGS

FIG. 1 is a section of a waterproof connector in an embodiment in a state where a first connector and a second connector are properly connected.

FIG. 2 is a perspective view showing the first connector.

FIG. 3 is a front view showing the first connector.

FIG. 4 is a perspective view showing the second connector.

FIG. 5 is a front view showing the second connector.

FIG. 6 is a plan view in section showing the second connector.

FIG. 7 is a section, corresponding to a cross-section along A-A of FIG. 5, showing the second connector.

FIG. 8 is a section, corresponding to a cross-section along B-B of FIG. 5, showing the second connector.

FIG. 9 is a front view showing a seal ring,

FIG. 10 is a side view showing the seal ring.

FIG. 11 is a plan view showing the seal ring.

### DETAILED DESCRIPTION

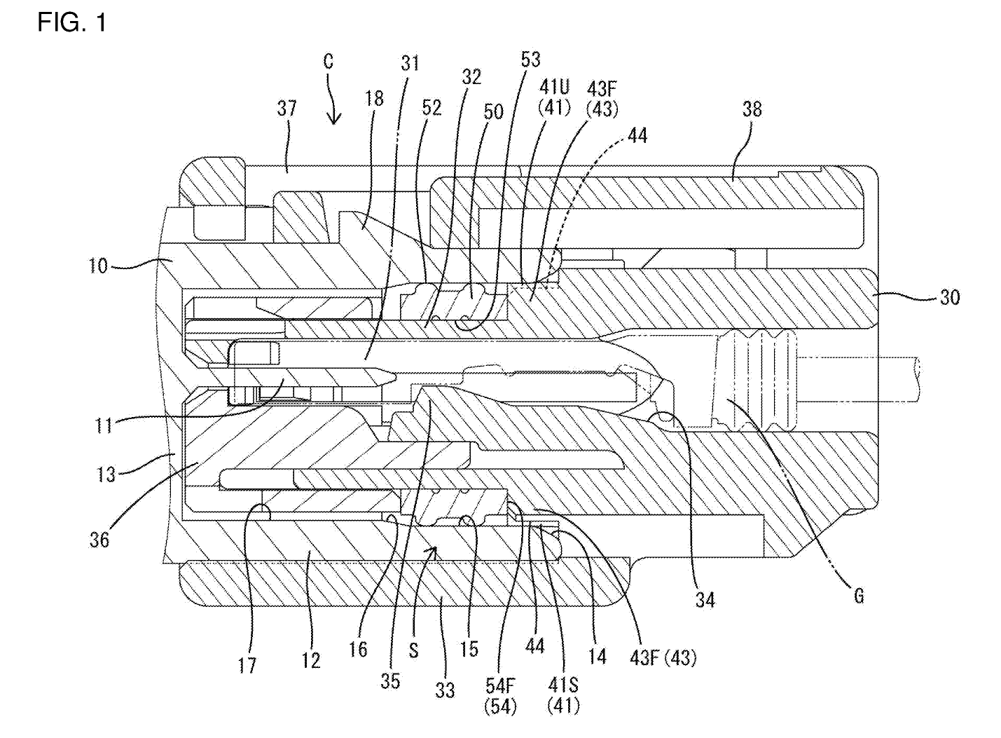

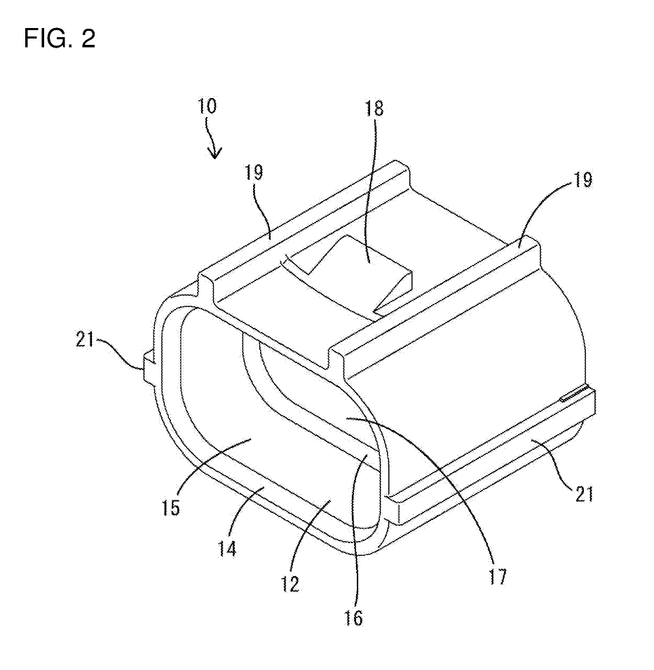

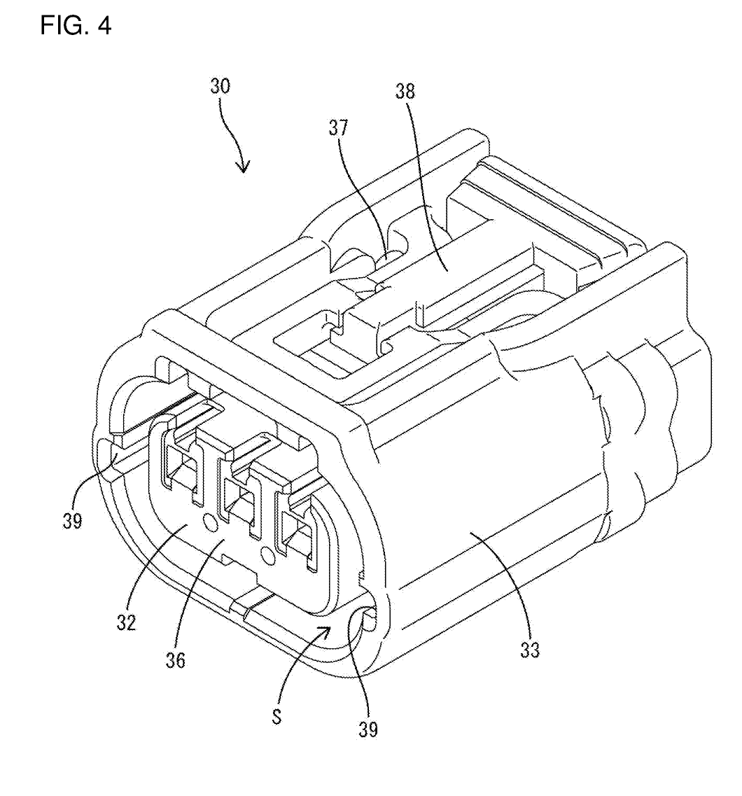

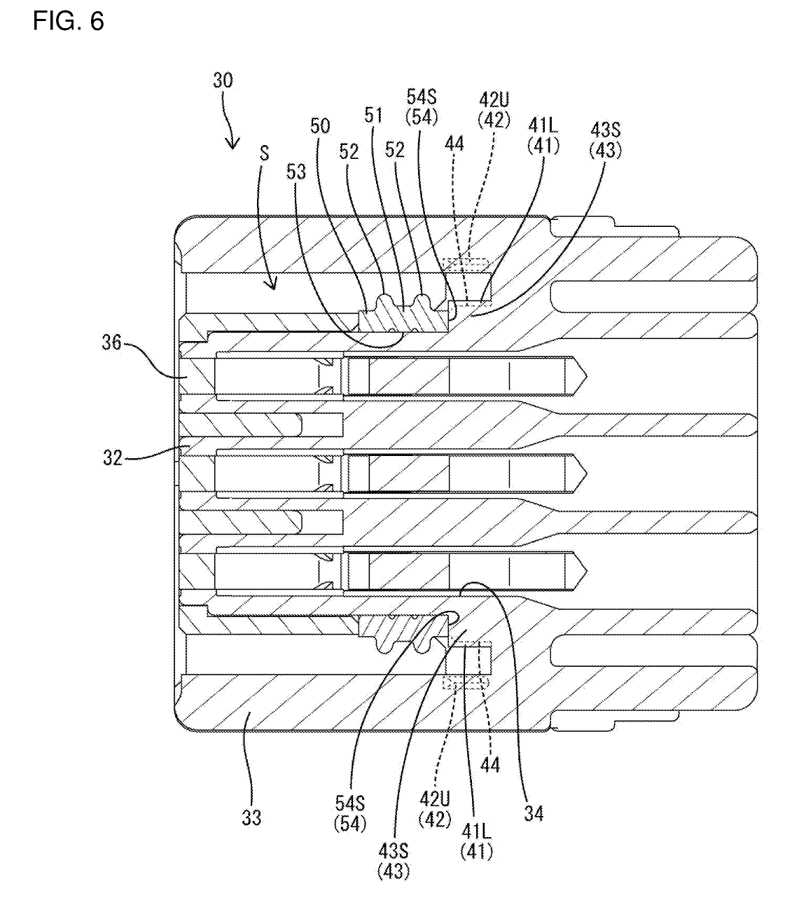

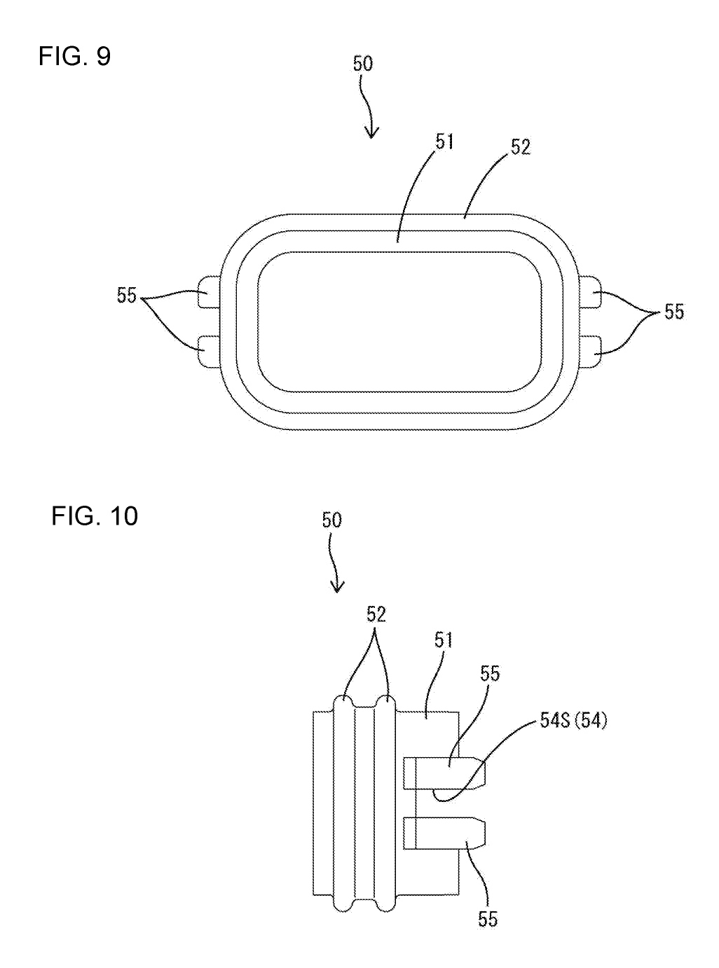

An embodiment of the invention is described in detail with reference to FIGS. 1 to 11. A waterproof connector C in this embodiment includes a first connector (mating connector) 10 and a second connector (connector) 30 that are connectable to each other, and fitting parts of the first connector 10 and the second connector 30 are sealed by a seal ring 50 as shown in FIG. 1. The first connector 10 constitutes a male connector with tab-like male first terminal fittings (mating terminal fittings) 11, and the second connector 30 constitutes a female connector with female second terminal fittings 31 electrically connectable to the first terminal fittings 11.

In each constituent member, connection surface sides (right side of FIG. 1 for the first connector 10, left side of FIG. 1 for the second connector 30) in the connectors 10, 30 are referred to respectively as fronts and upper and lower sides of FIG. 1 are referred to as upper and lower sides.

The first connector 10 is provided integrally on a case of an ECU for accommodating, for example, a circuit board inside.

The first connector 10 is made of synthetic resin harder than the second connector 30 such as PBT (polybutylene terephthalate) or SPS (syndiotactic polystyrene) containing glass fibers or like reinforcing fibers. The first connector 10 includes a receptacle 12 surrounding the first terminal fittings 11. The first terminal fittings 11 project forward from a back wall 13 of the receptacle 12. In this embodiment, three first terminal fittings 11 are disposed at equal intervals in a lateral direction.

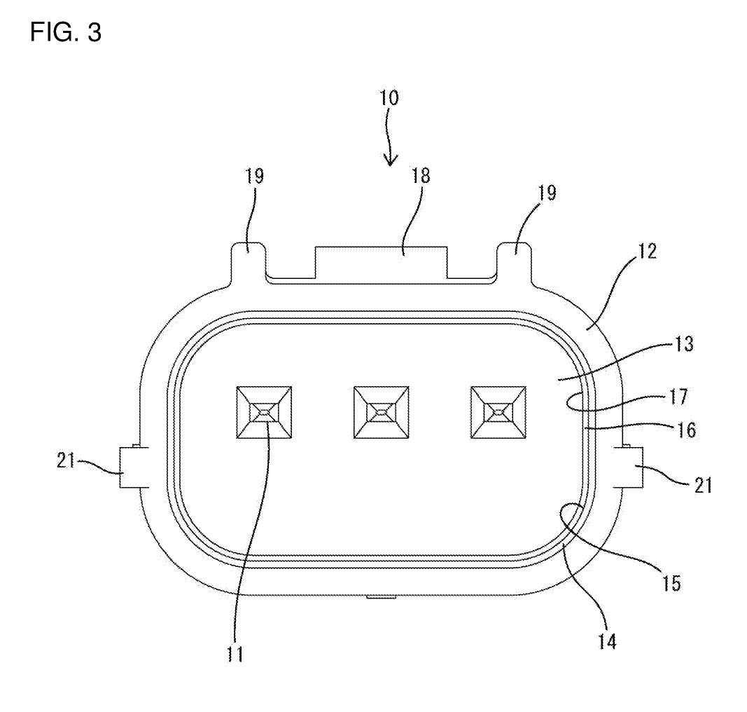

The receptacle 12 is in the form of a forwardly open tube. The receptacle 12 is long in the lateral direction when viewed from the front, as shown in FIG. 3. A tapered surface 14 is formed over the entire periphery on a leading end of the inner peripheral surface of the receptacle 12. The tapered surface 14 is inclined to protrude radially in from the tip of the receptacle toward the rear.

A first sealing surface 15 to be held in close contact with the seal ring 50 is formed continuously from the tapered surface 14 on the inner peripheral surface of the receptacle 14 (see FIG. 1). The first sealing surface 15 is formed on the inner peripheral surface of the receptacle 12 over the entire periphery and facing surfaces are parallel to each other and flat.

A step surface 16 is formed behind and continuously from the first sealing surface 15 on the inner peripheral surface of the receptacle 12. The step surface 16 is in a central part of the receptacle 12 in a front-rear direction and is inclined to protrude gradually radially in toward the rear. The step surface 16 is disposed substantially at the same portion as a lock projection 18 and the tips of the first terminal fittings 11 in the front-rear direction.

A back peripheral surface 17 is formed continuously from the step surface 16 on the inner peripheral surface of the receptacle 12. The back peripheral surface 17 is located inward of the receptacle 12 than the first sealing surface 15 and substantially parallel to the first sealing surface 15.

The lock projection 18 to which a lock arm 38 of the second connector 30 is lockable is provided on the upper surface of the receptacle 12. The lock projection 18 projects in a laterally central part of the upper surface of the receptacle 12 (see FIG. 3). Note that two upper surface ribs 19 extend in the front-rear direction at both left and right sides of the lock projection 18.

Side surface ribs 21 are provided on both left and right surfaces of the receptacle 12 and extend in the front-rear direction over the entire length of the receptacle 12. The left and right side surface ribs 21 are slightly below a vertical center. The side surface ribs 21 have a rectangular cross-section (cross-section perpendicular to the front-rear direction). Both upper and lower surfaces of the side surface ribs 21 are substantially parallel to the front-rear direction.

The second connector 30 is made of synthetic resin and includes a terminal holding portion 32 configured to hold the second terminal fittings 31 and to be accommodated inside the receptacle 12, and an outer tube 33 to fit outside the receptacle 12, as shown in FIG. 1.

Three cavities 34 for accommodating the second terminal fittings 31 are provided side by side in the lateral direction in the terminal holding portion 32. A resiliently deflectable locking lance 35 is cantilevered in each cavity 34 to retain the second terminal fitting 31. A cap 36 is fit to a front part of the terminal holding portion 32 to stop the second terminal fittings 31 in front. A rubber plug G for sealing is mounted on a wire at the same time as the second terminal fitting 31 is crimped to the wire.

A fitting space S into which the receptacle 12 is to be fit is provided between the outer tube 33 and the terminal holding portion 32. The outer tube 33 surrounds a substantially front half of the terminal holding portion 32. The upper surface of the outer tube 33 forms an open portion 37 that opens up. The lock arm 38 is provided in the open portion 37 and is deflectable in a vertical direction. When the first and second connectors 10 and 30 reach a properly connected state, the lock arm 38 is locked to the lock projection 18 of the first connector 10 to connect the connectors 10, 30 properly.

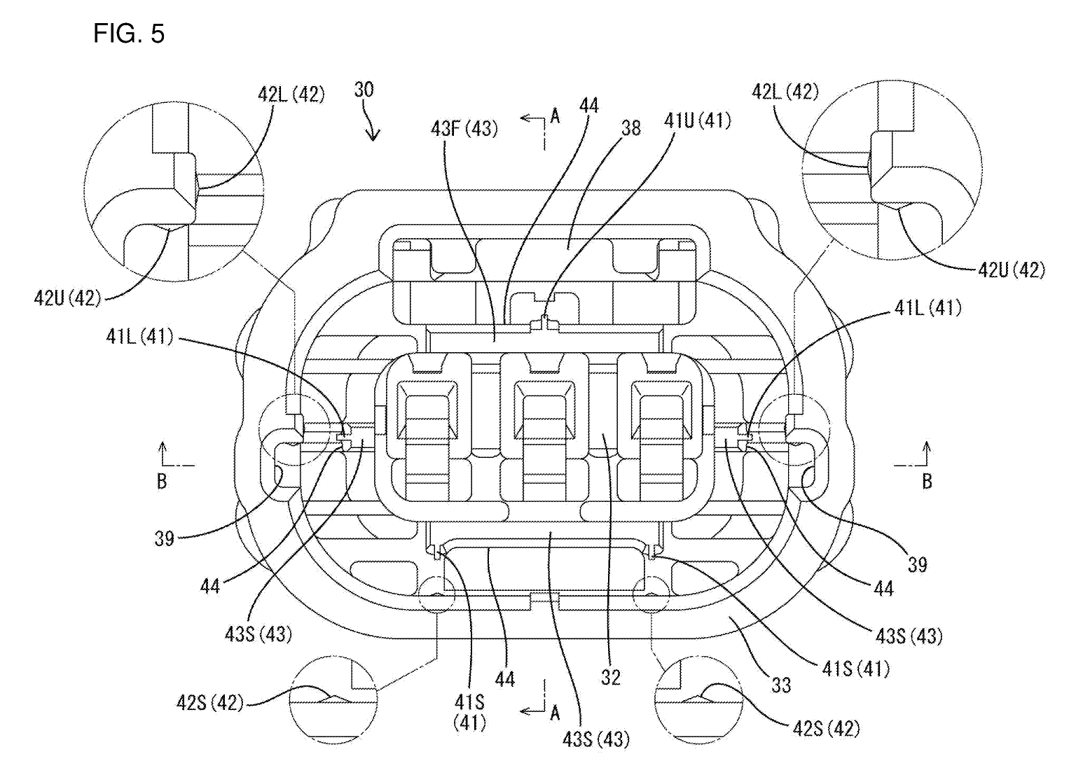

Side surface grooves 39 are provided in both left and right sides of the outer tube 33 (see FIG. 5) and receive the side surface ribs 21 of the first connector 10. Two of the side surface grooves 39 are provided in the left and right sides of the outer tube 33. The side surface groove 39 is shaped in conformity with the outer shape of the side surface rib 21 and formed by recessing the inner peripheral surface of the outer tube 33. The side surface groove 39 is disposed slightly below a vertical center of the outer tube 33.

The terminal holding portion 32 includes inner contacts 41 to be held in contact with the inner peripheral surface of the receptacle 12, and the outer tube 33 includes outer contact portions 42 to be held in contact with the outer peripheral surface of the receptacle 12. The inner and outer contacts 41, 42 are described in detail later.

As shown in FIG. 1, the seal ring 50 is held in close contact with the inner peripheral surface of the receptacle 12 and the outer peripheral surface of the terminal holding portion 32. The seal ring 50 is fit behind the cap 36 and in front of bases 43 (to be described later) on the outer peripheral surface of the terminal holding portion 32. Hereinafter, a surface to be held in close contact with the seal ring 50 is referred to as a second sealing surface 46.

The seal ring 50 includes a tubular body 51 surrounding the outer periphery of the terminal holding portion 32. Outer lips 52 to be held in close contact with the first sealing surface 15 of the receptacle 12 are provided on the outer peripheral surface of the body 51, and an inner lip 53 to be held in close contact with the outer peripheral surface of the terminal holding portion 32 is provided on the inner peripheral surface of the body 51. Fitting recesses 54 are provided in a rear end part of the seal ring 50 and are to be fit to the bases 43. The fitting recesses 54 are described in detail later.

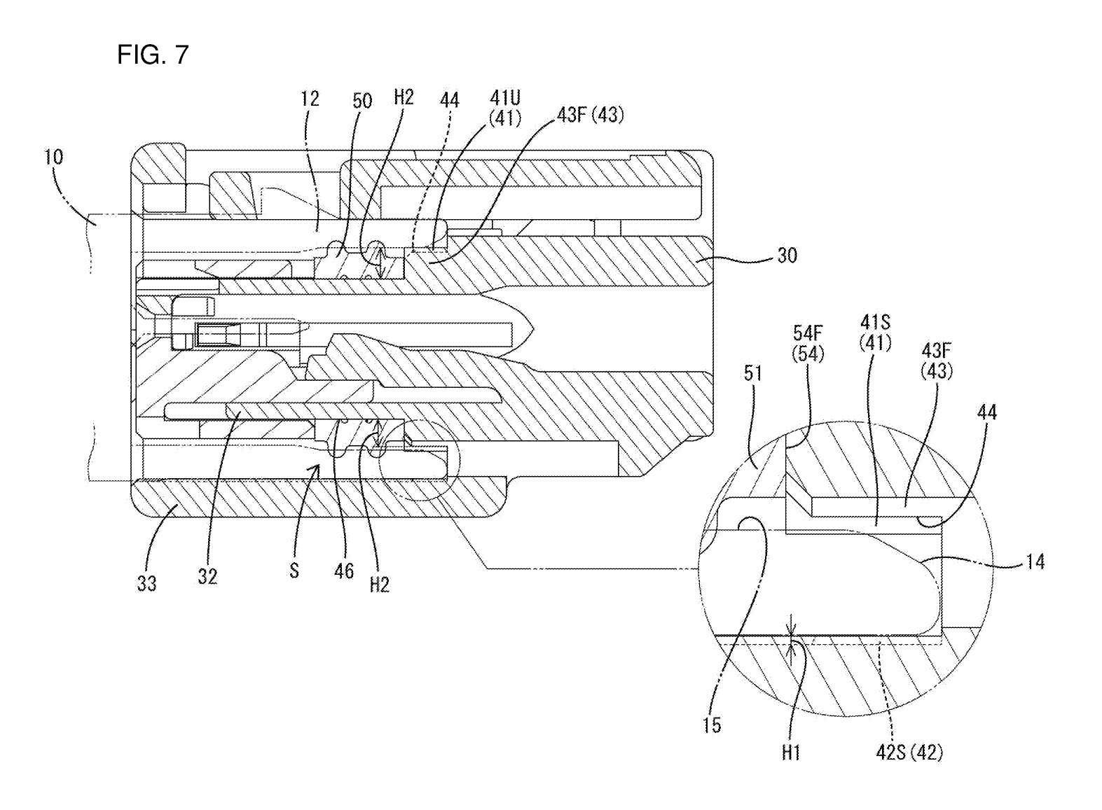

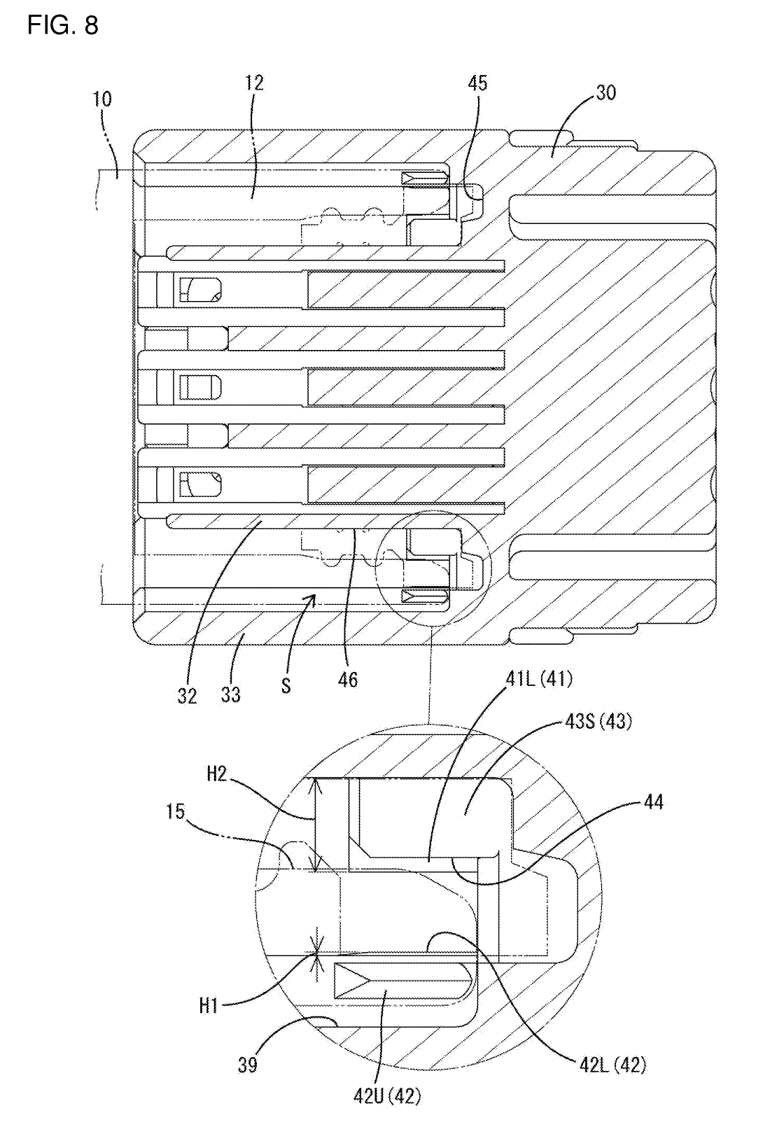

The bases 43 project on the outer peripheral surface of the terminal holding portion 32. As shown in FIG. 5, two bases 43 are provided on upper and lower sides of the terminal holding portion 32 and two bases 43 are provided on left and right sides of the terminal holding portion 32. As shown in FIGS. 7 and 8, the bases 43 are located in a rear part of the fitting space S. Projecting surfaces 44 of the bases 43 are disposed at positions lower than projecting ends of the outer lips 52. The front ends of the bases 43 are inclined to increase a projecting dimension gradually toward a rear end.

The bases 43 include two first bases 43F on the upper and lower sides of the terminal holding portion 32 and extending over substantially the entire widths of flat parts of the upper and lower surfaces of the terminal holding portions 32 except rounded parts on both left and right corners, as shown in FIG. 5. The first bases 43F have an equal height (dimension in the vertical direction) and an equal width (dimension in the lateral direction).

The bases 43 also include two second bases 43S on left and right sides of the terminal holding portion 32 and in vertically central parts of the left and right surfaces of the terminal holding portion 32, as shown in FIG. 5. The second bases 43S have equal heights (dimension in the lateral direction) and equal widths (dimension in the vertical direction).

The inner contact portion 41 is provided on the projecting surface 44 of the base 43. A dimension of the inner contact 41 in the front-rear direction is the entire dimension of the base 43 in the front-rear direction. The inner contact 41 is a wall having a dimension in the front-rear direction larger than a width (dimension in a circumferential direction of the terminal holding portion 32). When viewed from the front, the inner contact 41 has a substantially rectangular shape. The inner contact 41 is in contact with a front part of the first sealing surface 15.

The inner contacts 41 include an upper surface inner contact 41U on an upper surface of the terminal holding portion 32, lower surface inner contacts 41S on the lower surface and side surface inner contacts 41L on the left and right surfaces. The inner contacts 41 are symmetrical with respect to a lateral center of the terminal holding portion 32.

One upper surface inner contact 41U is in a laterally central part of the terminal holding portion 32. The upper surface inner contact 41U is in a laterally central part of the first base 43F. Two of the lower surface inner contacts 41S are near both lateral ends of the terminal holding portion 32. The lower surface inner contacts 41S are located on both lateral ends of the first base 43F. Specifically, the upper surface inner contact 41U and the lower surface inner contacts 41S differ in number.

Two side surface inner contacts 41L are provided in a vertically central part of the terminal holding portion 32. The side surface inner contacts 41L are located in vertically central parts of the second bases 43S.

The outer contacts 42 project on the inner peripheral surface of the outer tube 33. The outer contacts 42 are in contact with a leading end part (part corresponding to the tapered surface 14 and a front part of the first sealing surface 15) of the outer peripheral surface of the receptacle 12. As shown in FIGS. 7 and 8, a height H1 of the outer contact 42 from the inner peripheral surface of the outer tube 33 is smaller than a height H2 of the inner contact portion 41 from the second sealing surface 46. Note that the height H2 of the inner contact portion 41 from the second sealing surface 46 includes a height of the base 43.

As shown in FIG. 5, the outer contact portion 42 has a substantially triangular shape when viewed from the front. The front end of the outer contact 42 is inclined to gradually increase a projecting dimension toward the rear.

As shown in FIG. 5, the outer contacts 42 correspond to the inner contacts 41. Specifically, the outer contacts 42 include upper surface outer contact portions 42U corresponding to the upper surface inner contact 41U, lower surface outer contacts 42S corresponding to the lower surface inner contacts 41S and side surface outer contacts 42L corresponding to the side surface inner contacts 41L.

The upper surface outer contacts 42U are on both left and right sides of the outer tube 33. The upper surface outer contacts 42U project on the upper surfaces of the side surface grooves 39.

Two of the lower surface outer contacts 42S are on the lower surface of the outer tube 33. The lower surface outer contacts 42S are paired with the lower surface inner contacts 41S. The lower surface outer contacts 42S are at positions aligned with the lower surface inner contacts 41S in the lateral direction.

The side surface outer contact portions 42L are on the left and right sides of the outer tube 33. The side surface outer contacts 42L are paired with the side surface inner contacts 41L. The side surface outer contacts 42L are at positions substantially aligned with the side surface inner contacts 41L in the vertical direction. The side surface outer contacts 42L are located above the side surface grooves 39.

As shown in FIG. 5, the upper surface outer contacts 42U and the lower surface outer contacts 42S have the same shape. The side surface outer contacts 42L have a smaller projecting dimension than the upper surface outer contacts 42U and the lower surface outer contacts 42S.

The fitting recesses 54 to be fit to the bases 43 are in the rear end part of the seal ring 50. The fitting recesses 54 are formed by being cut forward from the rear surface of the body 51. The fitting recesses 54 are provided on both upper and lower sides and both left and right sides of the body 51.

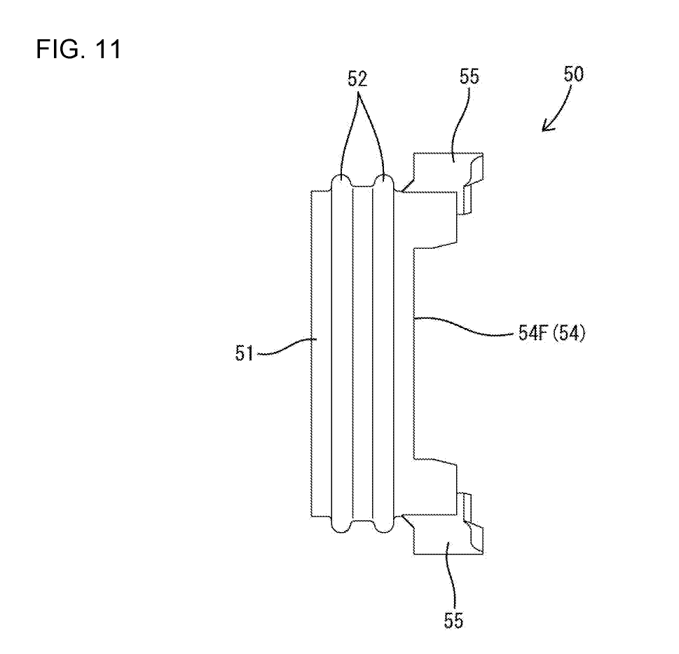

First fitting recesses 54F to be fit to the first bases 43F have a rectangular shape long in a circumferential direction of the body 51, as shown in FIG. 11. Second fitting recesses 54S to be fit to the second bases 43S have a rectangular shape long in the front-rear direction, as shown in FIG. 10.

Projecting pieces 55 are provided on both upper and lower sides of the second fitting recesses 54S to project out from the side surface of the body 51 and to project rearward from the rear surface of the body 51. The projecting pieces 55 are fit into recesses 45 in the rear surface forming the fitting space S of the second connector 30 (see FIG. 8).

The seal ring 50 is vertically and bilaterally symmetrical with respect to a center axis of the body 51. By fitting the fitting recesses 54 to the bases 43, a positional deviation of the seal ring 50 is prevented.

Next, functions and effects of this embodiment are described.

The second connector 30 of this embodiment is a connector fittable into the receptacle 12 of the first connector 10 and includes the terminal holding portion 32 configured to hold the second terminal fittings 31 connectable to the first terminal fittings 11 and to be fit inside the receptacle 12, and the outer tube 33 to be fit outside the receptacle 12. The terminal holding portion 32 includes the inner contacts 41 to be held in contact with the inner peripheral surface of the receptacle 12 in a properly connected state to the first connector 10, and the outer tube 33 includes the outer contacts 42 to be held in contact with the outer peripheral surface of the receptacle 12 in the properly connected state.

According to this configuration, with the first connector 10 and the second connector 30 properly connected, the inner contacts 41 on the terminal holding portion 32 are in contact with the inner surface of the receptacle 12 and the outer contacts 42 provided on the outer tube 33 are in contact with the outer surface of the receptacle 12 so that the first connector 10 and the second connector 30 cannot rattle.

The seal ring 50 is held in close contact with the inner peripheral surface of the receptacle 12 and the outer peripheral surface of the terminal holding portion 32. The inner contacts 41 project on the outer peripheral surface of the terminal holding portion 32, the outer contacts 42 project on the inner peripheral surface of the outer tube 33, and the heights of the inner contacts 41 from the second sealing surface 46 held in close contact with the seal ring 50 are larger than the heights of the outer contacts 42 from the inner peripheral surface of the outer tube 33. With the seal ring 50 held in close contact with the inner peripheral surface of the receptacle 12 and the outer peripheral surface of the terminal holding portion 32, an interval between the inner peripheral surface of the receptacle 12 and the outer peripheral surface of the terminal holding portion 32 tends to be larger than an interval between the outer peripheral surface of the receptacle 12 and the inner peripheral surface of the outer tube 33. However, according to this configuration, the inner contacts 41 can be in contact with the inner peripheral surface of the receptacle 12.

The inner contacts 41 are provided on the projecting surfaces 44 of the bases 43 to project on the outer peripheral surface of the terminal holding portion 32. According to this configuration, the heights can be increased by the bases 43. Accordingly, the heights of the inner contact 41 can be made smaller, and strength is excellent.

The seal ring 50 is in front of the bases 43 and the fitting recesses 54 to be fit to the bases 43 are provided in the rear part of the seal ring 50. According to this configuration, since the dimension of the second connector 30 in the front-rear direction can be reduced as compared to the case where the entire seal ring 50 is arranged in front of the bases 43, the waterproof connector C can be miniaturized.

The bases 43 include the two first bases 43F on upper and lower sides of the terminal holding portion 32 and the two second bases 43S on left and right sides of the terminal holding portion 32, and the dimensions of the first bases 43F and those of the second bases 43S in the circumferential direction of the terminal holding portion 32 are equal. According to this configuration, the dimensions of the first fitting recesses 54F on the upper and lower sides of the seal ring 50 and those of the second fitting recesses 54S on the left and right sides are equal. Thus, the seal ring 50 can be used in a vertically or laterally inverted orientation and the assembling operation of the second connector 30 can be facilitated.

Further, the first connector 10 is made of synthetic resin harder than the second connector 30. According to this configuration, when the waterproof connector C is connected and separated, the damage of the receptacle 12 by the inner contacts 41 or the outer contacts 42 is prevented. Particularly, since the inner contact portions 41 do not damage the first sealing surface 15 of the receptacle 12, a reduction in waterproofness by connection and separation can be prevented.

The invention is not limited to the above described and illustrated embodiment. For example, the following embodiments also are included in the scope of the invention.

Although the seal ring 50 is held in close contact with the inner peripheral surface of the receptacle 12 and the outer peripheral surface of the terminal holding portion 32 in the above embodiment, there is no limitation to this and a seal ring may be held in close contact with the front end surface of a receptacle and the rear surface of a fitting space or may be held in close contact with the outer peripheral surface of a receptacle and the inner peripheral surface of an outer tube.

Although the fitting recesses 54 are formed by being cut forward from the rear surface of the seal ring 50 in the above embodiment, there is no limitation to this and fitting recesses may be, for example, holes closed over the entire peripheries.

Although the inner contacts 41 are on the projecting surfaces 44 of the bases 43 in the above embodiment, there is no limitation to this and inner contacts may be provided on the outer peripheral surface of a terminal holding portion without providing any base.

Although the widths of the upper and lower first bases 43F and those of the left and right second bases 43S are respectively equal in the above embodiment, there is no limitation to this and widths of a corresponding pair of bases may be different.

Although the numbers and positions of the inner contacts 41 and the outer contacts 42 are illustrated in the above embodiment, there is no limitation to this and the numbers and positions of inner and outer contacts may be changed.

Although the invention is applied to the standardized receptacle 12 of the first connector 10 in the above embodiment, there is no limitation to this and the invention may be applied to an unstandardized receptacle of a first connector.

### LIST OF REFERENCE SIGNS

C waterproof connector
H1 height of outer contact
H2 height of inner contact
10 first connector (mating connector)
11 first terminal fitting (mating terminal fitting)
12 receptacle
30 second connector (connector)
31 second terminal fitting (terminal fitting)
32 terminal holding portion
33 outer tube
41 inner contact
42 outer contact
43 base
44 projecting surface
46 second sealing surface (surface to closely contact the seal ring)
50 seal ring
54 fitting recess

What is claimed is:

1. A connector (30) to be fit into a receptacle (12) of a mating connector (10), comprising:
a terminal holding portion (32) to be accommodated inside the receptacle (12); and
an outer tube (33) to be fit outside the receptacle (12);
the terminal holding portion (32) including an inner contact (33) to be held in contact with an inner peripheral surface of the receptacle (32) in a properly connected state to the mating connector (10); and
the outer tube (32) including an outer contact (42) to be held in contact with an outer peripheral surface of the receptacle (12) in the properly connected state.

2. The connector of claim 1, comprising a seal ring (50) to be held in close contact with the inner peripheral surface of the receptacle (12) and an outer peripheral surface of the terminal holding portion (32), wherein:
the inner contact (41) is formed to project on the outer peripheral surface of the terminal holding portion (32);
the outer contact (42) is formed to project on an inner peripheral surface of the outer tube (32); and
a height of the inner contact (41) from a surface held in close contact with the seal ring (50) is larger than a height of the outer contact (42) from the inner peripheral surface of the outer tube (32).

3. The connector of claim 2, wherein the inner contact (41) is provided on a base (43) formed to project on the outer peripheral surface of the terminal holding portion (32).

4. The connector of claim 3, wherein:
the seal ring (50) is located in front of the base (43); and
a fitting recess to be fit to the base (43) is provided in a rear part of the seal ring (50).

5. The connector of claim 4, wherein:
two of the bases (43) are provided on upper and lower sides or on left and right sides of the terminal holding portion (32); and
dimensions of the bases (43) in a circumferential direction of the terminal holding portion (32) are equal.

6. A waterproof connector, comprising:
a mating connector (10) including a receptacle (32) surrounding a mating terminal fitting (11); and
the connector of claim 1.

7. The waterproof connector of claim 6, wherein the mating connector (11) is made of synthetic resin harder than the connector (30).
